(19) United States
(12) Patent Application Publication
(10) Pub. No.: US 2011/0196749 A1
(43) Pub. Date: Aug. 11, 2011

(54) METHOD FOR DYNAMIC BANNER COMPOSITION

(75) Inventors: Gregory Charles Herlein, San Francisco, CA (US); Vincent E. Sartor, Benicia, CA (US); Cris Crews, San Francisco, CA (US)

(73) Assignee: Thomson Licensing

(21) Appl. No.: 12/737,563

(22) PCT Filed: Aug. 4, 2009
(86) PCT No.: PCT/US2009/004466

§ 371 Date: Jan. 25, 2011

Related U.S. Application Data
(60) Provisional application No. 61/188,409, filed on Aug. 8, 2008.

(51) Int. Cl. G06Q 30/00

(52) U.S. Cl. 705/14.72

(57) ABSTRACT

A display banner containing current and dynamically varying information is realized by a method for generating a display of a banner image, wherein the banner image occupies at least a portion of the video display. A file including certain instructions is used to define static and dynamic elements of the banner image. As the instructions from the file are executed to begin composing the banner image for display, a current content for each dynamic element is determined and the related dynamic element is updated accordingly. The static elements and the updated dynamic elements are then assembled into the current banner image for display. In this way, embodiments of the present invention are able to dynamically create banner images with current information just in time for their display.

### CROSS-REFERENCE TO RELATED APPLICATIONS

This application claims the priority benefit from U.S. Provisional Patent Application Ser. No. 61/188,409 filed Aug. 8, 2008, which is expressly incorporated by reference herein in its entirety.

### FIELD OF THE INVENTION

This invention relates to presentation systems and, more particularly, to a method for the dynamic composition of content for the display of banner ads.

### BACKGROUND OF THE INVENTION

Electronic advertising has continued its growth especially in the in-store environment. In this environment, a retailer may employ many different techniques to target shoppers and showcase products and sale items. For example, the retailer may use large flat-screen displays to show video segments about the store and different products while simultaneously showing a message about a sale item, commonly referred to as a banner, in another area of the display.

Advertising typically makes use of banners, which are typically overlaid on media content being displayed simultaneously on a display. As noted above, the banner is intended to attract the attention of viewers of the media content to the targeted advertising information on the banner. It is common today for banners and their information content to be provided by a host server in the retail store or in a larger network to which the retailer is connected. In general, known advertising systems compose banner ads as a playlist of one or more advertising segments, wherein the media content in each banner segment is prepackaged in a file for display in a particular order and/or at a particular time. Many such implementations use HTML technology to accomplish this composition. A region for the banner is created in the layout of the display screen and content including a graphic element or a video element is displayed in that region. Organizations such as the Interactive Advertising Bureau provide standard sizes for these regions in web browsers. From these standards, it is evident that a banner can cover a portion of the entire display area or it can span the entire display area.

For many applications, the banner and its content are fixed and static, so that the viewer will see the same banner advertisement, that is, the banner content, over and over for a long period of time. In other applications, banner advertising content is developed and determined in advance so that it can be pre-programmed into a play list that includes all the different content media segments that are programmed in a certain order for display according to a predetermined schedule. In some implementations, software is included for execution in the browser or player, usually written in the JavaScript programming language, that can change the media presented in the banner while the user observes the page.

Problems exist with each of these techniques. For example, it has long been determined that viewer have a very low positive response rate to fixed banners. Moreover, in many cases, viewers completely ignore fixed banner ads. That is, as an ad is repeated too frequently or too often, as is the case with fixed banners, consumers simply ignore the ad and, more importantly from the retailers standpoint, its content.

For banners that are pre-programmed to change in a predetermined manner according to a set play list of content, it is desirable to vary the content or message of the banners. This is usually accomplished by programmably scrolling in sequence through a series of advertisements represented by stored content media, usually stored remotely on a network media server. Such advertisements tend to make use of as much graphic information as possible so that the banners appear sufficiently interesting to attract consumers to shop and buy the products being advertised. In all these systems, the advertising content is determined in advance and set up into media files which are stored at an accessible location such as a content media server in the retail chain's network. This type of advertising content is therefore static and is the same for each day that it is run, at each location at which it is run, and for each viewer demographic for which it is run. As a result, the advertising content may lose some or all of its effectiveness for viewers in different store locations, for viewers at different locations in the same store, for viewers of varying demographics, or for viewers seeing the ad content on different days. The usual solution to this problem is to create, distribute, and present new versions of the media to provide different and more interesting media to the consumer. This solution is expensive because each new version of the media requires a complete production by graphic artists and producers. Each new piece of media must also be distributed to the end point, thereby consuming bandwidth and storage that also can be expensive. In addition, the playlist must somehow be altered to reflect the new media or some technique must be employed to provide a means to determine what new media is to be played in a banner region. All of these increase cost and complexity.

### SUMMARY OF THE INVENTION

It has been recognized herein that content distribution systems, such as retail advertising systems, need to be able to display localized information and timely information that is relevant to attract the attention of each different shopper. For example, it is now understood that screens that display the local weather forecast, the time, certain local information, and other information relevant to the current shoppers and that is up to the minute, for example, are more likely to attract attention and shopper interest. In a sense, this need can be understood as a capability for dynamic composition of some or all of the advertising content on banner ads to target shoppers in a timely and effective manner. Current available systems do not appear to have sufficient capabilities to fulfill this need.

Banner composition that fulfills this need for generating display that contain current, useful, pertinent, and dynamically varying information is achieved by embodiments of the present invention which define a method for generating a display of a video image and a banner image, wherein the banner image overlies at least a portion of the video image.

In one embodiment, a method includes a file including certain instructions used to define static and dynamic elements of the banner image. The instructions from the file are executed to begin composing the banner image. As the banner is being composed for display, a current content for the dynamic element or elements is determined and the related dynamic element or elements are updated accordingly. The static elements and the updated dynamic elements are then assembled into the current banner image for display. In this way, embodiments of the present invention are able to dynamically create video or images with current information in advance of and perhaps just in time for their display. In various applications, dynamic data such as the current day or time, the number of days remaining until some special event (such as Christmas), or localized information such as the name of that store or the local weather forecast can be determined at the time of display using currently available or determinable information.

Various embodiments of the present invention provide a means to change banner media dynamically based on a set of rules described in a file that is included in the rundown or playlist. A media server or player can use these rules to build or rebuild the banner media file in order to alter its appearance and make it more effective for advertising purposes.

### BRIEF DESCRIPTION OF THE DRAWINGS

The teachings of the present invention can be readily understood by considering the following detailed description in conjunction with the accompanying drawings, in which:

FIG. 1 depicts a simplified diagram of a display screen layout including both a video layer and a banner layer layout in accordance with the principles of the present invention;

FIGS. 2-4 depict three exemplary banner elements for use in accordance with the principles of the present invention;

FIG. 5, FIG. 6 and FIG. 7 depict separate examples of layering including a banner layer for a display screen layout in accordance with the principles of the present invention; and

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, for the dynamic composition of content banner ads. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any content distribution environment.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

Although other techniques are contemplated for realizing the various embodiments of the present invention, it should be understood that an exemplary embodiment of the present invention is realized by using an XML-based language, which is called herein a “Panel Description Language” (PDL). This language provides a way to describe the elements of a panel or graphical area such as the banner area in terms of how text and graphic elements are assembled. It is possible within the constructs of the language to identify color and location for text and graphic elements objects as well as the actual information being conveyed such as a line of text. A set of instructions in this panel description language can then instruct a graphics engine about the assembly of the different identified graphic elements into a single composite graphic or video for the banner. As such, a PDL file can act as a proxy for a media image file in a play list since the media image will be dynamically produced as the instructions in the PDL file are executed to completion.

A video presentation for display at a retail outlet, for example, is generated by inserting specific media files such as completed media clips or their file address or other location identifier into the ‘rundown’ or play list to program a presentation or show. In this way, the presentation or show is nothing more than a series of media clips defined in the play list for display in the pre-programmed order of the play list. Generally, the media in the presentation are used without further editing or abridgment, just the way they are supplied from post-production by professional graphics or video staff. These media in prior art systems are not usually capable of being modified to include pertinent real-time information or localized information that is available at the time of display.

According to an aspect of an embodiment of the present invention, it is possible for a media programmer to create a PDL file and insert the PDL file directly into the rundown or play list instead of specifying the finished media file as noted above. In this way, a PDL file offering the dynamic composition capability can take the place of the actual media or media location information in the play list or rundown. The newly created and inserted PDL file can be structured in such a way that it describes all the details needed by a playback system such as a media server or a set top box (STB) in order to assemble the media dynamically just before it is needed. For example, the PDL file could define a composition of fixed text and variable or dynamically generated information to be inserted at a specific location within the fixed text at the time the media is composed for display. Examples of dynamically generated information could be the store location, the time, the date, an externally generated text statement, or the like. Of course, it is contemplated that graphic information or a combination of text and graphics could be included in the dynamically generated information. In one, example from experimental practice, daily or day-part weather information including weather icon graphics as well as text was employed as dynamically generated information.

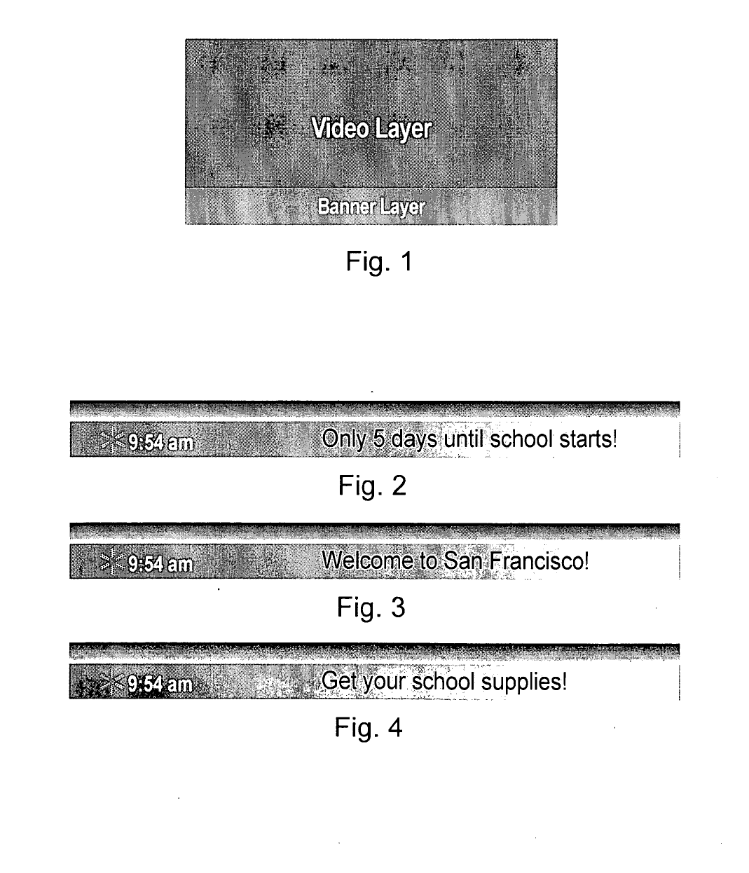

It is contemplated that various embodiments of the present invention are suitable for use with all digital display formats including all high definition formats. For example, an exemplary embodiment of the present invention included a display screen supporting full motion video at up to 1080i resolution with both a video layer and a banner layer as shown in FIG. 1.

FIG. 1 depicts a single banner image placed on screen as an overlay on top of the video layer. The layers are described in more detail below. The banner overlay image is dynamically generated in accordance with the principles of the embodiments of the present invention by video network manager software which is preferably resident in an in-store network. As described in more detail below, the banner image is generated to include at least some image graphic or text component that is variable and can be dynamically generated by the manager software. Of course, it is contemplated that the banner image also includes a static or fixed portion that does not change while the variable portion is dynamically generated. Several exemplary variable components for the banner image include, but are not limited to, the current time, the current day, the present store location, local weather information, a countdown number of days until a particular event or holiday, and the like. These variable components may be expressed as text, as a graphic image, or as a combination of text and a graphic image.

In accordance with various embodiments of the present invention, a method is described for generating a display of a banner image, wherein the banner image occupies at least a portion of a video display. The method is realized by performing instructions included in a file defining the banner image. The file is part of a larger play list or rundown that defines the entire display presentation. In one embodiment of the present invention, the banner image includes at least one static element and at least one dynamic element. A means for performing such instructions, such as a media server or set top box in a retail advertising environment, then determines a current content for the at least one dynamic element such as a date or time or location or weather condition or the like. Once the content is determined, the dynamic element is updated on a periodic basis, as needed, with the newly determined content. The dynamically generated banner image is then assembled using the at least one static element and the updated version of the at least one dynamic element.

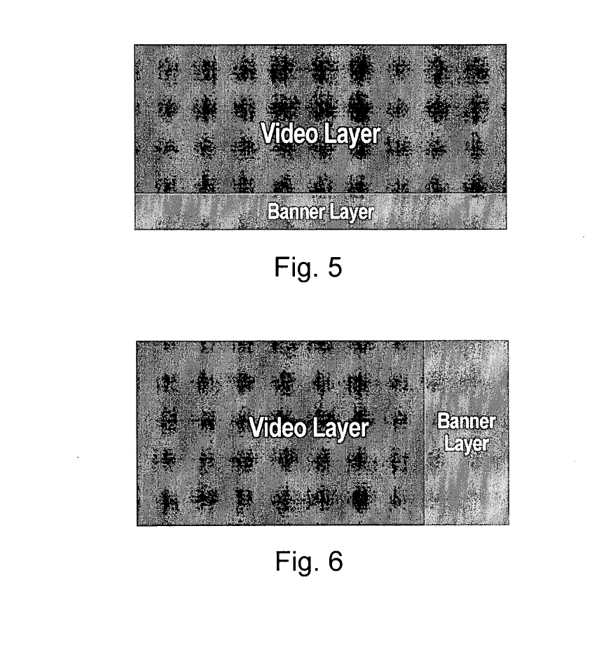

FIGS. 2-4 show different examples of dynamically generated banner images for use with the display shown in FIG. 1, wherein the exemplary banner images of FIGS. 2-4 are each intended to occupy the area of the display shown as the banner layer in FIG. 1. FIGS. 2 through 4 all show a portion of the banner image as including a current time of “9:54 am” depicted in an HH:MM am/pm format, where HH represents the one or two digit hour and MM represents the one or two digit minute.

FIG. 2 also includes a countdown in which the number of days until the selected event occurs is displayed. In FIG. 2, the selected event is the start date of school. The banner in the example of FIG. 2 is dynamically generated when it is to be displayed. Initially the banner image is developed with the static or fixed text of “Only [countdown] days until school starts!”, where [countdown] is intended to be the replaced by the actual countdown date computed by the software at the time of banner image display generation. In this case, the software will compute a difference between the event date and the current date to arrive at the value of [countdown]. When the countdown value is computed, it is inserted directly into the text stream to generate the countdown portion of the dynamic banner image shown in FIG. 2.

FIG. 3 also includes a store location displayed with a “Welcome” placed to the right of the current time. The banner in the example of FIG. 3 is also dynamically generated when it is to be displayed. As in FIG. 2, the banner image is initially developed with the static or fixed text of “Welcome to [location]!”, where [location] is intended to be the replaced by the actual store location such as its city or other definable geographic identifier such as its street or highway address, for example. The [location] data may be resident in a particular data file or memory storage location for retrieval by the software when the banner image is being dynamically generated. In this case, the software retrieves the value of [location]. When the location value is retrieved, it is inserted directly into the text stream to generate the location welcome portion of the dynamic banner image shown in FIG. 3.

In summary, FIGS. 2-4 show exemplary dynamic banners realized in accordance with the various embodiments of the present invention. Each banner shown in these figures is comprised of a sequence of images. Each image is includes text and/or graphics merged into one element. A single element is the result of the dynamic banner generation. In the description below, each unique presentation of a dynamic banner may also be referenced as an “element.” It is important to note that each dynamic banner includes a fixed or static portion into which one or more dynamic portions are inserted at the time of display. In this way, it is possible to produce a single static portion of the banner that is reused as the dynamic information changes. This eliminates the need for production of, for example, thirty different banner media clips, one for each of the thirty days before school starts. Instead, in the example given, only one file is created and reused on each of the thirty days with a spot for insertion of the dynamically generated countdown day at the time of display. Similar efficiencies are realized for each and every different type of dynamic banner.

As mentioned above, an XML-based panel description language has been used in experimental practice to realize the dynamic banners. Exemplary PDL files are shown below for each of the dynamic banners shown in FIGS. 2-4. It is contemplated that the appropriate slot for the dynamic banner in a rundown or play list will be populated by the corresponding PDL file instead of with a specific media file name pointing to a media clip for the banner. The media clip may be a static image such as a still picture or graphic or the clip may be a video image. The use of the term “media” is intended to include all such images, whether still or motion or video or graphic or the like. In contrast to the media files in the play list or rundown, the PDL file includes instructions for the dynamic banner composition layer to use to build the dynamic banner.

In one embodiment of the present invention, a text string insertion for the dynamic banner, for example, in FIG. 3 is achieved by a PDL file shown below. The dynamic banner panel is named “whatever” and is designed to fit in the space shown at the bottom of FIG. 1 for the banner layer. As shown in this example, the dynamic variables of {TIME} and {TOKEN1} are computed and retrieved, respectively, when the PDL file instructions are executed. The variable {TIME} refers to the current time displayed on the left side of the banner, whereas the variable {TOKEN1} refers to the store location held in a file and shown on the right side of the banner in FIG. 3. The PDL file for this example is as follows:

```
<panel name=″whatever″ type=″dynamic_image″>
    <output>
        <type>PNG</type>
    </output>
    <background>
        <file>background.png</file>
        <size width=″960″ height=″100″ left=″0″ top=″0″/>
    <background>
    <graphic_elements>
        <graphic id=”logo” type=”insertion”>
        <size width=″100″ height=″100″/>
        <file>logo1.png</file>
        <location left=”100” top=”100” zindex=”10” />
        </graphic>
    </graphic_elements>
    <text_elements>
        <text_string>
        <text size=”12” font=”arial” color=”#010101”>{TIME}</text>
        <location left=”100” top=”100” zindex=”10” />
    </text_string>
    <text_string>
        <text size=”12” font=”arial” color=”#010101”>
        Welcome to {TOKEN1}
        </text>
        <location left=”100” top=”100” zindex=”10” />
    </text_string>
    </text_elements>
    <tokens>
        <token name=″TIME″ type=”time”/>
        <token name=″TOKEN1″ type=”replace”>
        <file>c:\path\to\local\store\name</file>
        </token>
    </tokens>
</panel>.
```

In a manner similar to the simple text string insertion shown directly above, a date referenced countdown text string insertion for the dynamic banner similar to the one shown in FIG. 2 can be achieved by a PDL file shown below. In the exemplary file below, the countdown is referenced to Christmas, Dec. 25, 2008, with a text script that reads as “Only ______ days until Christmas!” Again, the dynamic banner panel is named “whatever” and is designed to fit in the space shown at the bottom of FIG. 1 for the banner layer. As shown in this example, the dynamic variables of {TIME} and {TOKEN1} are computed and retrieved, respectively, when the PDL file instructions are executed. The variable {TIME} refers to the current time displayed on the left side of the banner, whereas the variable {TOKEN1} refers to the number of days left in the countdown to Christmas computed by the banner generator and shown on the right side of the banner in FIG. 2. The PDL file for this example is as follows:

```
<panel name=″whatever″ type=″dynamic_image″>
    <output>
        <type>PNG</type>
    </output>
    <background>
        <file>background.png</file>
        <size width=″960″ height=″100″ left=″0″ top=″0″/>
    <background>
    <graphic_elements>
        <graphic id=”logo” type=”insertion”>
        <size width=″100″ height=″100″/>
        <file>logo1.png</file>
        <location left=”100” top=”100” zindex=”10” />
        </graphic>
    </graphic_elements>
    <text_elements>
    <text_string>
        <text size=”12” font=”arial” color=”#010101”>{TIME}</text>
        <location left=”100” top=”100” zindex=”10” />
    </text_string>
<text_string>
    <text size=”12” font=”arial” color=”#010101”>
    Only {TOKEN1} days until Christmas!
    </text>
    <location left=”100” top=”100” zindex=”10” />
</text_string>
    </text_elements>
<tokens>
    <token name=″TIME″ type=”time”/>
    <token name=″TOKEN1″ type=”countdown” date=”12/25/2008”/>
</tokens>
</panel>.
```

In a further example not depicted in the figures, a weather forecast is dynamically inserted into a banner at the time of display by executing the PDL file instructions shown below. The weather forecast includes four weather icons together with their associated date information. The weather icons and associated dates depict the weather for the present day and the weather outlook for the next three days. The weather icons are intended to be graphic images while the date information is intended to be textual. While daily weather is shown in this example, it is contemplated that the banner could be dynamically generated to include more or fewer days or hourly weather or day-part weather such as morning, afternoon and evening day parts or other such variations. The PDL file for this example is as follows:

```
<panel name=″whatever″ type=″dynamic_image″>
<output>
    <type>PNG</type>
</output>
<background>
    <file>background.png</file>
    <size width=″960″ height=″100″ left=″0″ top=″0″/>
</background>
<graphic_elements>
<graphic id=”logo” type=”insertion”>
    <size width=″100″ height=″100″/>
    <file>logo1.png</file>
    <location left=”100” top=”100” zindex=”10” />
</graphic>
<graphic id=”logo” type=”weather”>
    <size width=″100″ height=″100″/>
    <location left=”100” top=”100” zindex=”10” />
    <date>TODAY</date>
</graphic>
<graphic id=”logo” type=”weather”>
    <size width=″100″ height=″100″/>
    <location left=”200” top=”100” zindex=”10” />
    <date>TODAY+1</date>
</graphic>
<graphic id=”logo” type=”weather”>
    <size width=″100″ height=″100″/>
    <location left=”300” top=”100” zindex=”10” />
    <date>TODAY+2</date>
</graphic>
<graphic id=”logo” type=”weather”>
    <size width=″100″ height=″100″/>
    <location left=”200” top=”100” zindex=”10” />
    <date>TODAY+3</date>
</graphic>
</graphic_elements>
<text_elements>
    <text_string>
    <text size=”12” font=”arial” color=”#010101”>{TIME}</text>
    <location left=”100” top=”100” zindex=”10” />
    </text_string>
    <tokens>
        <token name=″TIME″ type=”time”/>
    </tokens>
</panel>.
```

In the embodiment of the present invention described directly above concerning weather icons, it should be understood that there are many sources for obtaining weather information over the Internet or other available networks. Generally, it would be expected that local weather could be obtained on the basis of geographic location information such as address or zip code or the like.

It is contemplated that a system realized in accordance with the various embodiments of the present invention would be able to support insertion of three or four weather icons into the banner based on actual weather forecasts for the store location. In accordance with the embodiments of the present invention, such icons can be provided as graphics in any suitable graphic format such as a PNG format. Examples of weather icons representative of different forecast types include: sunny, partly cloudy, cloudy, foggy, showers, rain, thunderstorms, and snow. Of course, other weather icons could be added to this list based on predominant weather conditions for a particular geographic area.

Synchronization between the banner and the overlaid video presentation may be an issue in certain realizations. While it may be necessary to synchronize the banner and video in certain instances, it is contemplated herein that the banner is not synchronized to the video. As a result, the banner elements will appear in sequence as determined in the rundown or play list independent of the video presentation.

From experimental practice, it has been found that the graphics layer in at least one commercially available set top box can have a full screen size of 960×540 pixels, whereas the video layer has a maximum resolution of 1920×1080 pixels—exactly double the graphics layer. In this exemplary embodiment, these layers fill the exact same space. This means that pixels in the graphics layer are twice as wide and twice and high as video pixels. The only practical implication for this exemplary embodiment is that images are to be scaled to be no more than 960×540 pixels. In any event, the exact height of the banner can be determined by a user.

Since a layering approach has been used in the exemplary embodiments shown herein, it has been found that the graphics layer in at least one commercially available STB can be designed to support transparency as well as any particular color palette such as 16-bit color.

Text fonts need not be limited to those fonts resident in the system. Special fonts may be added as needed. It has been found that TrueType™ fonts packaged in available Windows platforms can be implemented in the dynamic banner. It is contemplated that the player for the present invention is capable of supporting any text size in pixels. Text size for the banner is expected to be a design choice by the retail store to achieve a certain visual fit for a particular text string length. Text color is similar to the graphics color above and should be designed to include transparency.

As described above, in various embodiments of the present invention, the display can be generated by a video/graphics player such as a Set Top Box (STB) player. One exemplary embodiment of such a commercially available STB supports the display of several ‘layers’ of imagery such as a video layer, and HTML layer, an image layer, a Flash™ layer, a scrolling ticker layer, and the like.

In this layering approach, it is preferable for the video layer to be on the bottom. Other layers can be stacked atop the video layer in any desired order. It should be appreciated that, for lower layers to appear visible, the higher layers must have regions of transparency in the area of the desired visible portions of the lower layers or those higher layers must not overlay the lower layer.

It is contemplated that the video layer be designed to support various digital video formats including high quality high definition (HD) video up to 1080p25 resolution video. At a 1080 HD resolution, the canvas for video is 1920×1080 pixels.

An HTML Layer can be defined to occupy a canvas sized up to 960×540 pixels, which is identical to the size of the image layer described below. Any valid web page can be rendered in this area using HTML. In the HTML layer, it is contemplated that animated GIF files can be used.

As noted above, the Image Layer can occupy a canvas sized up to 960×540 pixels. In various embodiments, images can be supported in at least the following formats: PNG, JPG, and GIF.

In one embodiment, the Flash™ Layer can occupy a canvas sized up to 960×540 pixels, which is also identical to the image layer. The nominal version of Flash™ that the player supports is Version 7, at this time. While it is understood that the effective frame rate for Flash™ animations is extremely limited by the hardware, it should also be recognized that the more important contributor to reducing the effective frame rate is the other activity being performed by the player at the time of the rendering. For example, if the player is decoding HD video and attempting to render animated Flash™ at the same time, then the effective frame rate suffers. This, in turn, may be deleterious to the viewing experience by a shopper or consumer viewing the display.

In one embodiment, the Scrolling Ticker Layer can occupy a canvas sized up to 960×540 pixels, which is again identical to the image layer. The STB allows control of the text size, color, scroll speed, rotation (on the screen so that it supports portrait mode), direction, and background color. There is no technical limit on the length of the text in the scrolling ticker, but of course there are practical limits based on perception of the viewer.

In one embodiment, the banner can be implemented in any of these layers that support video or still images. In the current exemplary implementation using a commercially available STB, the banner is contemplated as being supported using the still image layer.

It should be understood by persons skilled in this art that the definition of all the different layers described above in terms of a number of pixels is merely for illustrative purposes and not for purposes of limitation. The number of pixels in a region is usually determined in whole or in part by the chip set utilized by the STB or other display device.

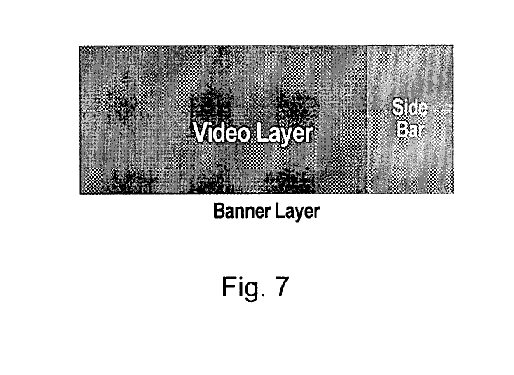

FIGS. 5, 6 and 7 depict alternatives for the layering of the video and banner layers on the display in accordance with the principles of the present invention. FIG. 5 is substantially identical to the display in FIG. 1 in that the video layer is overlaid by a banner layer situated across a bottom portion of the display. It should be apparent to those skilled in the art that the banner layer can be placed across either the top portion (not shown in the figures) or the bottom portion of the display. FIG. 6 shows an alternate display configuration in which the video layer is overlaid by a banner layer situated from top to bottom across the right side portion of the display. It should be apparent to those skilled in the art that the banner layer can be placed on either the left side (not shown in the figures) or the right side of the display. It should also be apparent to those persons skilled ion the art that the display can support multiple banners such as on both the top and bottom of the display or on the left and right or multiple banners in a similar location. When multiple banners are used in a similar location such as at the bottom of a display, different effects or scroll rates or the like may be employed to differentiate the messages in the separate banners.

FIG. 7 shows yet another display configuration in which the video layer is overlaid by a banner layer situated across a bottom portion of the display and also in which an additional layer called a “side bar” is overlaid on the remaining video layer along the right side. The placement of the side bar and the banner can, of course, be moved to other locations and orientations as mentioned above. The side bar is simply another type of banner region that can be used to provide additional information to the viewer.

Although the embodiments of the present invention have been described herein using a layering approach, it will be appreciated by persons skilled in the art that the banner need not overlie any video portion of the display. Instead, in alternate embodiments of the invention, the display may be partitioned into one or more mutually exclusive regions that substantially fill the entire display. In this manner, the main video may be displayed in one region while the banner is displayed in a different region separate from the first region. Such an approach may eliminate the need for layer transparency since no region would overlay another region.

In certain embodiments of the invention, it is contemplated that the display would show only the banner image. In this case, the banner image would consume the display or it would be limited to a particular region of the display, but there would be no contemporaneous video image in the other region or regions of the display.

In certain descriptions of the embodiments disclosed above, it has been noted that the dynamic element(s) of the banner image can be determined and updated at the time of display. This is but one alternative contemplated for the realization of the present invention. In alternative scenarios, it is contemplated that the dynamic portion of the banner image can be determined, updated, and composed at some point in time that is prior to its display. That it, it can be rendered just a bit ahead of the time that it is needed for display. Moreover, it is contemplated that a plurality of consecutive dynamic banner images could be rendered in advance of the time that they are needed for display. The STB or the server could perform the rendering of the dynamic banners. The particular alternative approach could be selected on the basis of the operational capabilities of the STB or the server and the bandwidth and storage available for these devices.

Having described various embodiments for a method for the dynamic composition of content banner ads (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for generating a display of a banner image, wherein the banner image occupies at least a portion of a video display, the method comprising:
performing instructions included in a file defining said banner image, said banner image including at least one static element and at least one dynamic element;
determining a current content of the at least one dynamic element;
updating periodically said at least one dynamic element with said current content from the determining step; and
assembling said at least one static element and said at least one dynamic element, as updated, in order to form a current banner image.

2. The method as defined in claim 1, wherein said at least one dynamic element includes a date and wherein said at least one static element includes a sequence of text characters.

3. The method as defined in claim 2 wherein said periodically updating is performed on at least a substantially daily basis.

4. The method as defined in claim 1, wherein said at least one dynamic element includes a time and wherein said at least one static element includes a sequence of text characters.

5. The method as defined in claim 4 wherein said periodically updating is performed at least once for every minute interval.

6. The method as defined in claim 1, wherein said at least one dynamic element includes a countdown number from a date certain and wherein said at least one static element includes a sequence of text characters.

7. The method as defined in claim 6 wherein said updating periodically is performed on at least a substantially daily basis.

8. The method as defined in claim 6 wherein said determining includes computing a difference between a current date and the date certain to generate said countdown number as the current content.

9. The method as defined in claim 1, wherein said at least one dynamic element includes a weather condition icon and wherein said at least one static element includes a sequence of text characters.

10. The method as defined in claim 8 wherein said updating periodically is performed on at least a substantially daily basis.

11. The method as defined in claim 1, wherein said at least one dynamic element includes a geographic location of the display and wherein said at least one static element includes a sequence of text characters.

12. The method as defined in claim 1 wherein said determining is performed substantially at a time of display for the banner image.

13. The method as defined in claim 1 wherein said determining is performed prior to a time of display for the banner image.

14. The method as defined in claim 12 wherein the method is performed to produce a plurality of consecutive banner images.

15. The method as defined in claim 1, where the file is included in a play list in place of an actual media file name.
